(19) United States
(12) Patent Application Publication
(10) Pub. No.: US 2026/0236948 A1
(43) Pub. Date: Aug. 13, 2026

(54) APPROACH PROPOSAL DEVICE

(71) Applicant: NTT DOCOMO, INC., Tokyo (JP)

(72) Inventors: Kyouko TAKAHASHI, Tokyo (JP); Norihiro KATSUMARU, Tokyo (JP)

(73) Assignee: NTT DOCOMO, INC., Tokyo (JP)

(21) Appl. No.: 19/153,360

(22) PCT Filed: Apr. 8, 2024
(86) PCT No.: PCT/JP2024/014311

§ 371 Date: Aug. 4, 2025

(30) Foreign Application Priority Data
May 19, 2023 (JP) 2023-082968

(51) Int. Cl. G06Q 30/0201; G06Q 30/0204

(52) U.S. Cl. CPC G06Q 30/02011; G06Q 30/0204

(57) ABSTRACT

An approach proposal device includes circuitry configured to obtain estimated inner aspects which are results of estimating a plurality of inner aspects of users for a target user group, which is a set of users serving as targets, using behavior data of the users, use the estimated inner aspects to extract positive example inner aspects which are a plurality of inner aspects characteristic of a positive example user group which is a set of users who are performing a predetermined behavior in the target user group, identify a plurality of clusters for the target user group using at least some of the positive example inner aspects, and estimate and output an approach for encouraging a behavior change for each of the plurality of clusters on the basis of the estimated inner aspects.

### TECHNICAL FIELD

The present invention relates to an approach proposal device.

### BACKGROUND ART

Techniques related to marketing have been proposed. Patent Literature 1 discloses a technique of visualizing customer values and conducting marketing tailored to customer needs. The technique disclosed in Patent Literature 1 calculates the degree of similarity corresponding to the customer's behavior and estimates the customer's financial values.

Patent Literature 2 discloses a technique of improving the accuracy of appeals. The technique disclosed in Patent Literature 2 classifies consumer values using all or part of the consumer's purchasing behavior or consciousness.

Patent Literature 3 discloses a technique of proposing an approach suited to each user. The technique disclosed in Patent Literature 3 outputs estimated values of features related to consumption behavior using the behavior history of a user to be estimated as input.

### CITATION LIST

### Patent Literature

[Patent Literature 1] Japanese Unexamined Patent Publication No. 2019-46493

[Patent Literature 2] Japanese Unexamined Patent Publication No. 2021-43899

[Patent Literature 3] Japanese Unexamined Patent Publication No. 2022-96488

### SUMMARY OF INVENTION

### Technical Problem

Conventional techniques enabled approaching users themselves or users having similar inner aspects such as values. However, conventional techniques were unable to approach users who have dissimilar inner aspects.

An object of the present disclosure is to provide a technique that makes it possible to approach users who have dissimilar inner aspects.

### Solution to Problem

According to an aspect of the present disclosure, there is provided an approach proposal device including: an inner aspect estimation unit configured to obtain estimated inner aspects which are results of estimating a plurality of inner aspects of users for a target user group, which is a set of users serving as targets, using behavior data of the users; an inner aspect feature extraction unit configured to use the estimated inner aspects to extract positive example inner aspects which are a plurality of inner aspects characteristic of a positive example user group which is a set of users who are performing a predetermined behavior in the target user group; a cluster identification unit configured to identify a plurality of clusters for the target user group using at least some of the positive example inner aspects; and a behavior change estimation unit configured to estimate and output an approach for encouraging a behavior change for each of the plurality of clusters on the basis of the estimated inner aspects.

In the approach proposal device according to an aspect of the present disclosure, estimated inner aspects, which are results of estimating a plurality of inner aspects from behavior data, are output for each user in the target user group. Positive example inner aspects, which are a plurality of inner aspects characteristic of the positive example user group in the target user group, are extracted from the estimated inner aspects. Clusters are specified for each user using at least some of the positive example inner aspects. For each cluster, an approach for encouraging a behavior change is estimated on the basis of the estimated inner aspects. According to such a configuration, the inner aspects characteristic of the positive example user group are treated as positive example inner aspects, and an approach for encouraging a behavior change is estimated for each cluster in accordance with the estimated inner aspects. This allows different approaches to be estimated, for example, for clusters having dissimilar inner aspects. As a result, it is possible to approach users who have dissimilar inner aspects through the clusters.

### Advantageous Effects of Invention

According to the present disclosure, it is possible to provide a technique that makes it possible to approach users who have dissimilar inner aspects.

### BRIEF DESCRIPTION OF DRAWINGS

FIG. 1 is an overview diagram illustrating an example of users.

FIG. 2 is a block diagram illustrating an example of a functional configuration of an approach proposal system.

FIG. 3 is a diagram illustrating an example of data used to create an inner aspect estimation model.

FIG. 4 is a flowchart illustrating an example of operation of an approach proposal device.

FIG. 5 is a diagram illustrating an example of data acquired by an input unit.

FIG. 6 is a diagram illustrating an example of data used in an inner aspect feature extraction unit.

FIG. 7 is a diagram illustrating an example of axis inner aspects.

FIG. 8 is a diagram illustrating an example of classification of clusters.

FIG. 9 is an example of a graph.

FIG. 10 is a diagram illustrating an example of feature values.

FIG. 11 is a diagram illustrating an example of data stored in a behavior change database.

FIG. 12 is a diagram illustrating an example of a hardware configuration of an approach proposal system according to an embodiment of the present disclosure.

### DESCRIPTION OF EMBODIMENTS

An embodiment of the present disclosure will be described with reference to the accompanying drawings. The same components are denoted, if possible, by the same reference numerals and signs, and thus description thereof will not be repeated.

An approach proposal system of the present disclosure estimates and outputs an approach for encouraging a user to change his/her behavior. The user is, for example, a person who is a target of marketing. Behavior change refers to a change in a user's behavior. The term “approach” refers to an action or a proposed method that influences the behavior change. The approach may be, for example, but not limited to, an activity or text, an advertisement or recommendation based on the activity or text, or the like. In the present disclosure, a set of users serving as targets is referred to as a “target user group.” A set of users who are performing a predetermined behavior in the target user group is referred as a “positive example user group.” The predetermined behavior is, for example, an expected behavior. Examples of the expected behavior include, but are not limited to, a purchase, a movement to a specific location, and the like.

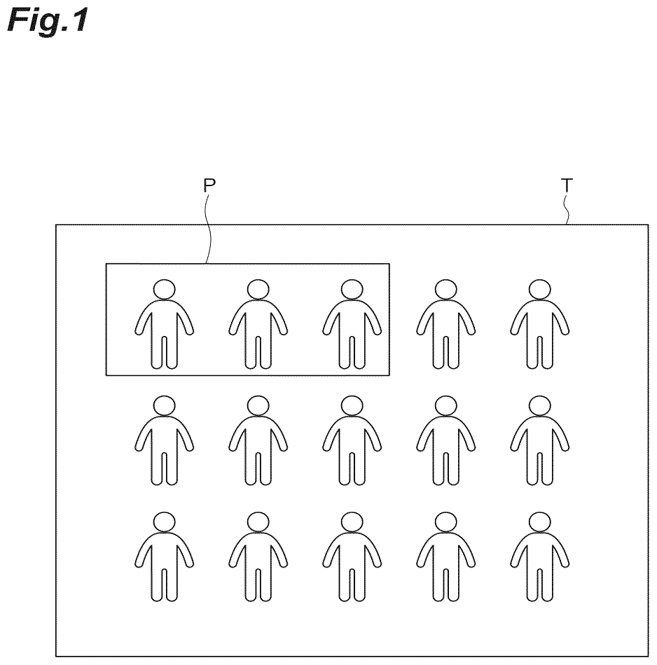

FIG. 1 is an overview diagram illustrating an example of users. FIG. 1 shows a target user group T and a positive example user group P. In an example, the target user group T is a set of fans of an idol. The positive example user group P is a set of fans who have participated in an event of the idol. The predetermined behavior is participation in the event of the idol. Examples of the event include a concert and a handshake event. The target user group T can include fans who have participated in the event of the idol and fans who have not participated in the event of the idol.

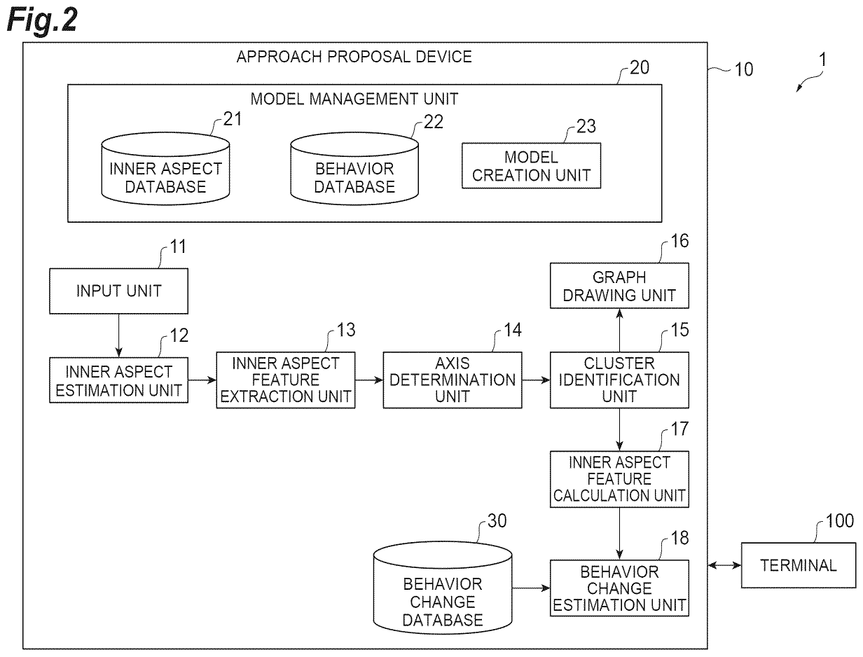

FIG. 2 is a block diagram illustrating an example of a functional configuration of an approach proposal system 1. The approach proposal system 1 includes an approach proposal device 10 and a terminal 100. The approach proposal device 10 is communicably connected to the terminal 100 through a network or the like.

The terminal 100 is, for example, a computer used by a person who uses the approach proposal system 1. The type of the terminal 100 is not limited. For example, the terminal 100 may be a personal computer. The terminal 100 may be a high-performance cellular phone (smartphone), a tablet terminal, a wearable terminal, or the like.

The approach proposal device 10 includes, as functional elements, a model management unit 20, an input unit 11, an inner aspect estimation unit 12, an inner aspect feature extraction unit 13, an axis determination unit 14, a cluster identification unit 15, a graph drawing unit 16, an inner aspect feature calculation unit 17, and a behavior change estimation unit 18. In addition, the approach proposal device 10 includes a behavior change database 30.

The model management unit 20 manages a machine learning model that estimates the inner aspects of a user (hereinafter referred to as an “inner aspect estimation model”). The inner aspects are a concept including, for example, at least one of values, consciousness, personality, cognitive bias, or behavior characteristics. Examples of the inner aspects include, but are not limited to, a desire for approval, extroversion, and aggressiveness. The number of inner aspects is not limited, and may be, for example, 100. The model management unit 20 includes an inner aspect database 21, a behavior database 22, and a model creation unit 23. The model management unit 20 may be provided in a computer system separate from the approach proposal device 10.

The inner aspect database 21 is a non-transitory storage medium or storage device that stores inner aspect data of some users. Some users may be part of the target user group T, or may be users other than the target user group T. The inner aspect data is electronic data indicating values or parameters corresponding to each inner aspect. The inner aspect data is acquired in advance, for example, by answering a questionnaire. In the questionnaire, question items and answer items are created on the basis of, for example, a psychological scale. The inner aspect database 21 stores the inner aspect data of a user in association with a user ID. The user ID is an identifier that uniquely identifies the user.

The behavior database 22 is a non-transitory storage medium or storage device that stores behavior data of some users. The behavior data is electronic data obtained by vectorizing the user's behavior. The behavior data may also be referred to as behavioral feature quantities. The behavior data is acquired in advance from terminals of some users or the like. Examples of the behavior data include, but are not limited to, semantic vectors of application usage information, payment information, and position information. The behavior database 22 stores the behavior data in association with a user ID.

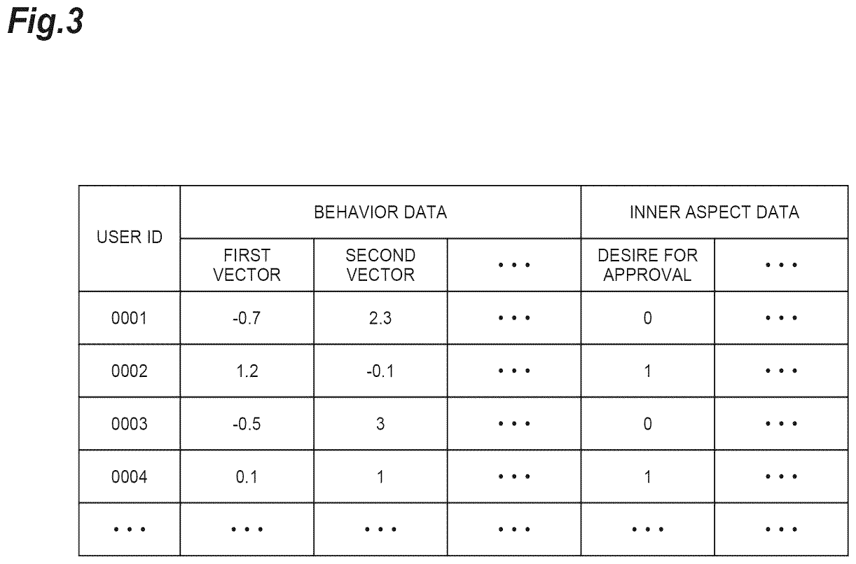

The model creation unit 23 creates an inner aspect estimation model using the inner aspect data and the behavior data. For example, the model creation unit 23 associates the inner aspect data and the behavior data with each other using a user ID. FIG. 3 is a diagram illustrating an example of data used to create an inner aspect estimation model. FIG. 3 shows an example in which the inner aspect data and the behavior data are associated with each other using a user ID. In an example, a user ID “0001” is associated with a first vector “−0.7” and a second vector “2.3” which are behavior data, and a desire for approval “0” which is inner aspect data. The first vector and the second vector are values obtained by vectorizing behaviors different from each other.

The model creation unit 23 creates an inner aspect estimation model by performing machine learning with the behavior data as an explanatory variable and the inner aspect data as an objective variable. The model creation unit 23 creates an inner aspect estimation model for each piece of inner aspect data. The learning method for the inner aspect estimation model is not limited. The model creation unit 23 may store the created inner aspect estimation model in a predetermined storage medium or storage device. The inner aspect estimation model inputs behavior data of a user to output estimation results obtained by estimating a plurality of inner aspects of the user. The estimation results can be represented by values or parameters corresponding to each inner aspect.

Referring back to FIG. 2, the input unit 11 acquires various types of information of the target user group T. For example, the input unit 11 acquires a user ID, behavior data, and information indicating a positive example user. The information indicating a positive example user is, for example, a flag indicating whether the user corresponds to the positive example user group P (hereinafter referred to as a “positive example user flag”). The input unit 11 may accept, for example, input of various types of information on the target user group T from the terminal 100. The input unit 11 may read out various types of information on the target user group T stored in advance in a predetermined storage unit or storage device.

The inner aspect estimation unit 12 obtains estimated inner aspects which are results of estimating a plurality of inner aspects of users for the target user group T, using behavior data of the users. For example, the inner aspect estimation unit 12 estimates the inner aspects of the user by performing an extended estimation using the inner aspect estimation model. The inner aspect estimation unit 12 obtains the estimated inner aspects of a user by inputting the behavior data of the user into the inner aspect estimation model. The inner aspect estimation unit 12 obtains the estimated inner aspects of each user in the target user group T.

The inner aspect feature extraction unit 13 uses the estimated inner aspects to extract positive example inner aspects which are a plurality of inner aspects characteristic of the positive example user group P in the target user group T. For example, the inner aspect feature extraction unit 13 extracts the positive example inner aspects by comparing the inner aspects of the positive example user group P with the inner aspects of the target user group T. The positive example inner aspects are part of the estimated inner aspects. An example of a process of extracting the positive example inner aspects will be described later.

The axis determination unit 14 determines axis inner aspects which are a plurality of axes serving as references on the basis of positive example inner aspects. The axis inner aspects are part of the positive example inner aspects. The number of axis inner aspects is not limited, and may be, for example, two or three. The axis inner aspects can be used as axes of a graph. The graph is drawn by the graph drawing unit 16 to be described later.

The cluster identification unit 15 identifies a plurality of clusters for the target user group using at least some of the positive example inner aspects. For example, the cluster identification unit 15 identifies a plurality of clusters using the axis inner aspects. The cluster identification unit 15 identifies a plurality of clusters by comparing values of the axis inner aspects of each user with a predetermined threshold. The predetermined threshold may be different for each axis inner aspect, or may be a common value. An example of the cluster identification process will be described later.

The graph drawing unit 16 draws a graph using the axis inner aspects for each of the plurality of clusters. For example, the graph drawing unit 16 draws a graph using the axis inner aspects as axes. In an example, in a case where there are two axis inner aspects, the graph drawing unit 16 draws a two-axis graph.

The inner aspect feature calculation unit 17 calculates a feature value related to each of the estimated inner aspects for each of the plurality of clusters. For example, the inner aspect feature calculation unit 17 calculates an average value of the estimated inner aspects as a feature value for each cluster.

The behavior change estimation unit 18 estimates and outputs an approach for encouraging a behavior change for each of the plurality of clusters on the basis of the estimated inner aspects. For example, the behavior change estimation unit 18 estimates and outputs an approach for encouraging a behavior change for each of the plurality of clusters using an inner aspect corresponding to a high value among the feature values. The behavior change estimation unit 18 acquires various types of information from the behavior change database 30, which will be described later, using an inner aspect with a high feature value as an extraction condition. It can also be said that an inner aspect with a high feature value indicates an inner aspect with a low feature value. For example, it can also be said that a user with a high value of cooperativeness is a user with a low value of assertiveness. The behavior change estimation unit 18 outputs the estimated approach.

The behavior change database 30 is a non-transitory storage medium or storage device that stores effective phrases or recommended behaviors for each inner aspect. It can also be said that the behavior change database 30 stores approaches for encouraging a behavior change in accordance with the inner aspects. The behavior change database 30 may be constructed as a single database, or may be a set of a plurality of databases. There are no limitations on the location where the behavior change database 30 is installed. For example, the behavior change database 30 may be provided in a computer system separate from the approach proposal device 10.

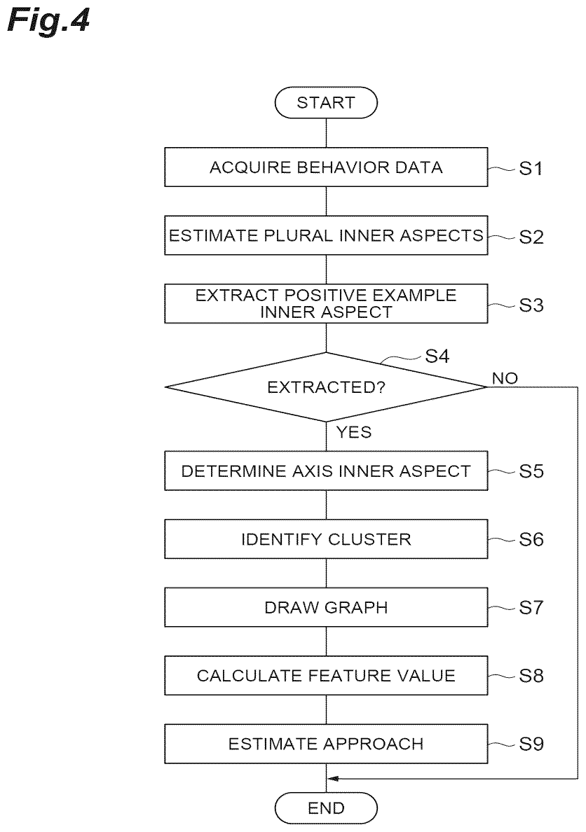

An example of an operation method performed by the approach proposal device 10 will be described with reference to FIGS. 4 to 11. FIG. 4 is a flowchart illustrating an example of operation of the approach proposal device 10. In the flow of FIG. 4, description will be given on the assumption that the inner aspect estimation model has already been created by the model management unit 20.

In step S1, the approach proposal device 10 acquires the behavior data of the target user group T. For example, the input unit 11 acquires user IDs of the target user group T, behavior data, and positive example user flags.

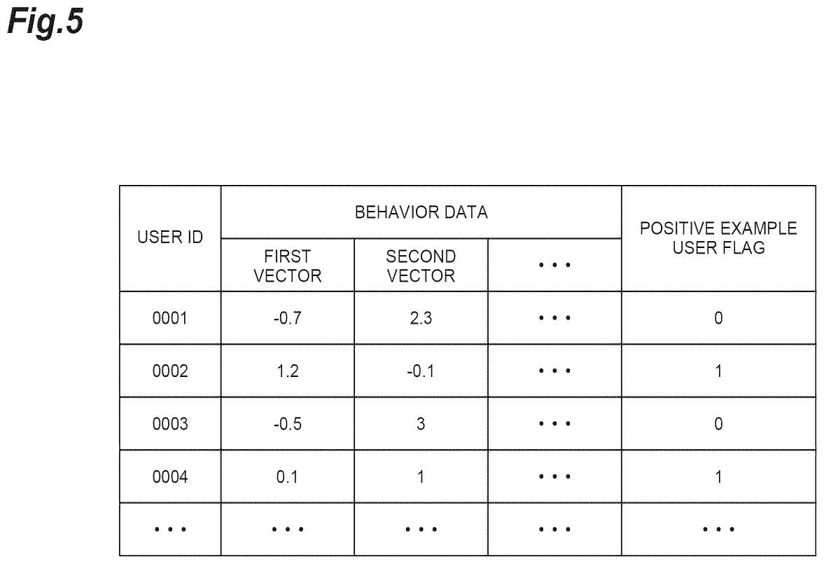

FIG. 5 is a diagram illustrating an example of data acquired by the input unit 11. For example, the input unit 11 acquires a user ID, a first vector and a second vector which are behavior data, and a positive example user flag. The first vector and the second vector indicate examples of the behavior data of the target user group T. The positive example user flag is, for example, “0” in a case where the user does not correspond to a positive example user, and is “1” in a case where the user corresponds to a positive example user.

In an example, the input unit 11 acquires a first vector “−0.7” of a user corresponding to the user ID “0001,” a second vector “2.3” of the user, and a positive example user flag “0” of the user. The input unit 11 acquires a first vector “1.2” of the user ID “0002,” a second vector “−0.1” of the user, and a positive example user flag “1” the user. The input unit 11 acquires a first vector “−0.5” of a user of the user ID “0003,” a second vector “3” of the user, and a positive example user flag “0” of the user. The input unit 11 acquires a first vector “0.1” of a user of the user ID “0004,” a second vector “1” of the user, and a positive example user flag “1” of the user.

Referring back to FIG. 4, in step S2, the approach proposal device 10 estimates a plurality of inner aspects for each user of the target user group T. For example, the inner aspect estimation unit 12 estimates a plurality of inner aspects using data as illustrated in FIG. 5. The inner aspect estimation unit 12 obtains the estimated inner aspects which are results of estimating a plurality of inner aspects of users for the target user group T, using the behavior data of the users. The inner aspect estimation unit 12 obtains the estimated inner aspects of the users by inputting the behavior data of the users into the inner aspect estimation model. The inner aspect estimation unit 12 obtains the estimated inner aspects of each user in the target user group T.

In step S3, the approach proposal device 10 extracts a plurality of positive example inner aspects. For example, the inner aspect feature extraction unit 13 uses the estimated inner aspects to extract positive example inner aspects which are a plurality of inner aspects characteristic of the positive example user group P in the target user group T. The inner aspect feature extraction unit 13 extracts the positive example inner aspects by comparing the inner aspects of the positive example user group P with the inner aspects of the target user group T.

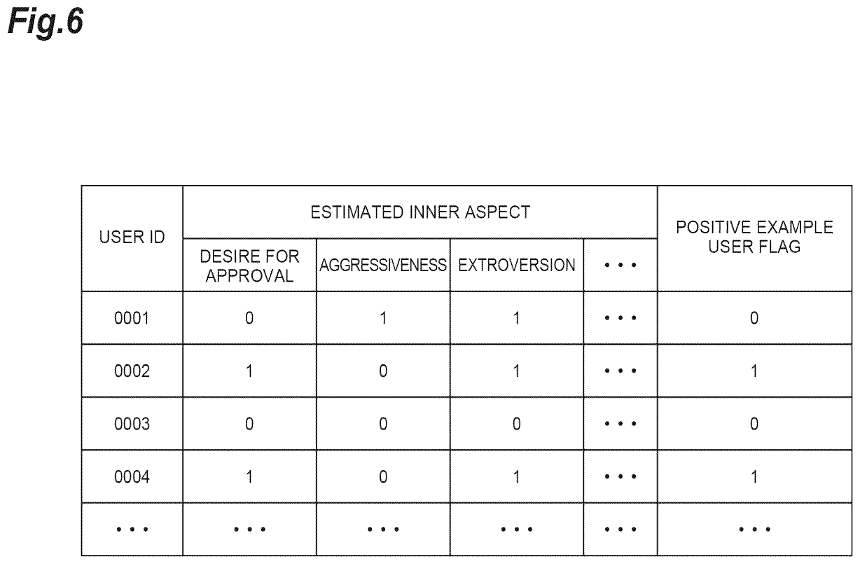

An example of a process of extracting the positive example inner aspects will be described with reference to FIG. 6. FIG. 6 is a diagram illustrating an example of data used in the inner aspect feature extraction unit 13. The inner aspect feature extraction unit 13 acquires the estimated inner aspects of the target user group T and data indicating which users are positive example users. For example, the inner aspect feature extraction unit 13 acquires the estimated inner aspects and positive example user flags associated with the user IDs.

The inner aspect feature extraction unit 13 creates a machine learning model using the acquired data. For example, the inner aspect feature extraction unit 13 performs machine learning using the estimated inner aspects as feature quantities and the positive example user flag as training data. The inner aspect feature extraction unit 13 extracts features which are prominently exhibited in the positive example user group P during the process of machine learning. The inner aspect feature extraction unit 13 may extract the strength of features of a plurality of positive example inner aspects.

For example, the inner aspect feature extraction unit 13 extracts important feature quantities which are feature quantities that contribute to the prediction of positive example users. For example, the inner aspect feature extraction unit 13 extracts important feature quantities using SHAP (SHapley Additive explanations). The ranking of the strength of features of inner aspects appears in the important feature quantities. The inner aspect feature extraction unit 13 extracts features of inner aspects which are ranked highly (for example, two or three) in terms of the important feature quantities. It can be said that the features of highly-ranked inner aspects are features which are prominently exhibited in the positive example user group P. The inner aspect feature extraction unit 13 may output the highly-ranked inner aspects as positive example inner aspects.

Referring back to FIG. 4, in a case where the positive example inner aspect is extracted in step S3 (YES in step S4), the process proceeds to step S5. In a case where the positive example inner aspect cannot be extracted in step S3 (NO in step S4), the subsequent process ends.

In step S5, the approach proposal device 10 determines axis inner aspects. For example, the axis determination unit 14 determines axis inner aspects which are a plurality of axes serving as references on the basis of the positive example inner aspects. The axis determination unit 14 determines a positive example inner aspect having a strong feature among a plurality of positive example inner aspects as an axis inner aspect. In an example, the axis determination unit 14 determines two positive example inner aspects among the plurality of positive example inner aspects as two axis inner aspects.

The axis determination unit 14 may determine the axis inner aspects on the basis of the ranking of the strength of features of the positive example inner aspects. For example, the axis determination unit 14 may determine the highly-ranked two positive example inner aspects in the ranking of the strength of features of the positive example inner aspects as the two axis inner aspects. The axis determination unit 14 may determine the positive example inner aspects extracted by the inner aspect feature extraction unit 13 in accordance with the ranking of the strength as the axis inner aspects.

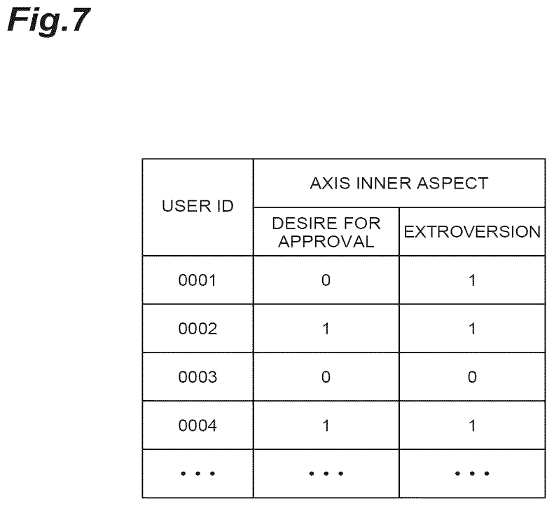

FIG. 7 is a diagram illustrating an example of axis inner aspects. FIG. 7 shows “desire for approval” and “extroversion” as two axis inner aspects. In this case, it can be said that “desire for approval” and “extroversion” are features which are prominently exhibited in the positive example user group P.

Referring back to FIG. 4, in step S6, the approach proposal device 10 identifies a cluster for each user. For example, the cluster identification unit 15 identifies a plurality of clusters for the target user group using at least some of the positive example inner aspects. The cluster identification unit 15 identifies a plurality of clusters using the axis inner aspects. The cluster identification unit 15 identifies a plurality of clusters by comparing the value of the axis inner aspect of each user with a predetermined threshold. In an example, the cluster identification unit 15 performs cluster classification by comparing the value of the axis inner aspect “desire for approval” and the value of the axis inner aspect “extroversion” with a predetermined threshold.

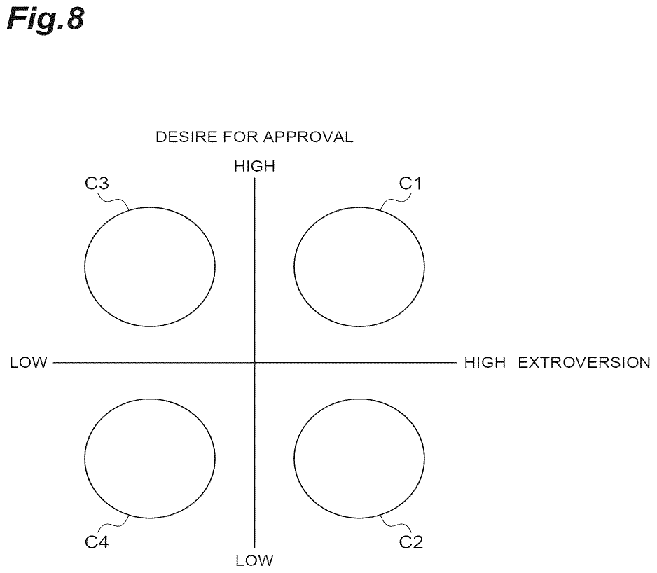

An example of the cluster identification process will be described with reference to FIG. 8. FIG. 8 is a diagram illustrating an example of classification of clusters. FIG. 8 shows a division into four quadrants based on the combination of the high/low level of “desire for approval” and the high/low level of “extroversion.” The classification of clusters is not limited to four.

The cluster identification unit 15 identifies a plurality of clusters by comparing values of the axis inner aspects with a predetermined threshold and determining which of the clusters divided in accordance with a combination of the axis inner aspects the values correspond to. For example, the cluster identification unit 15 determines whether the value of each axis inner aspect is high or low based on a predetermined threshold. The cluster identification unit 15 may identify a user who has a high level of “desire for approval” and a high level of “extroversion” as a cluster C1. The cluster identification unit 15 may identify a user who has a low level of “desire for approval” and a high level of “extroversion” as a cluster C2. The cluster identification unit 15 may identify a user who has a high level of “desire for approval” and a low level of “extroversion” as a cluster C3. The cluster identification unit 15 may identify a user who has a low level of “desire for approval” and a low level of “extroversion” as a cluster C4.

Referring back to FIG. 4, in step S7, the approach proposal device 10 draws a graph. For example, the graph drawing unit 16 draws a graph for each of the plurality of clusters using the axis inner aspects. For example, the graph drawing unit 16 draws a graph using the axis inner aspects as axes. In an example, in a case where there are two axis inner aspects, the graph drawing unit 16 draws a two-axis graph. The graph drawing unit 16 may display the drawn graph on a display device, or may cause it to be displayed on the display device of the terminal 100. The graph drawing unit 16 may display the value of the axis inner aspect for each cluster on the display device, or may transmit it to the terminal 100.

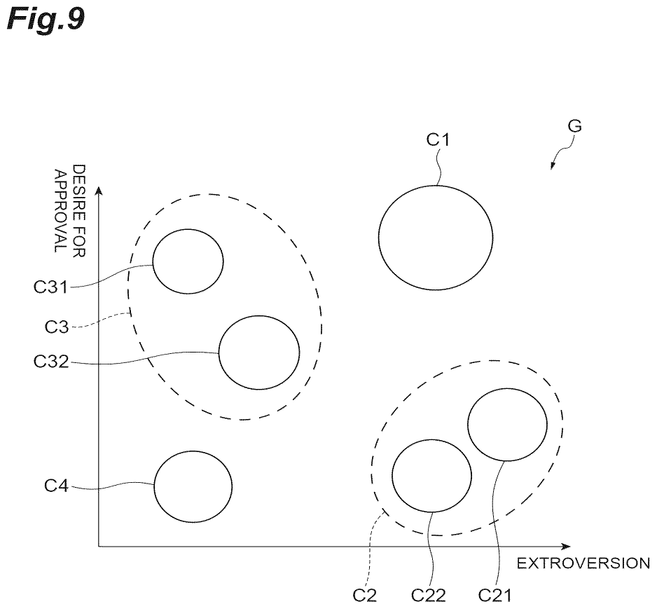

FIG. 9 is an example of a graph. In a graph G shown in FIG. 9, the vertical axis is “desire for approval” and the horizontal axis is “extroversion.” The graph G shows clusters C1 to C4. For example, the cluster Cl is a cluster with a high value of “desire for approval” and a high value of “extroversion.” The cluster C1 is a cluster to which the positive example user and a user who has an inner aspect with a high similarity to the inner aspect (desire for approval and extroversion) of the user belong. The cluster C2 is a cluster to which a user having a low value of “desire for approval” and a high value of “extroversion” belongs. The cluster C2 may include clusters C21 and C22. The cluster C3 is a cluster to which a user having a high value of “desire for approval” and a low value of “extroversion” belongs. The cluster C3 may include clusters C31 and C32. The cluster C4 is a cluster to which a user having a low value of “desire for approval” and a low value of “extroversion” belongs.

Referring back to FIG. 4, in step S8, the approach proposal device 10 calculates feature values related to the estimated inner aspects. For example, the inner aspect feature calculation unit 17 calculates feature values related to each of the estimated inner aspects for each of the plurality of clusters.

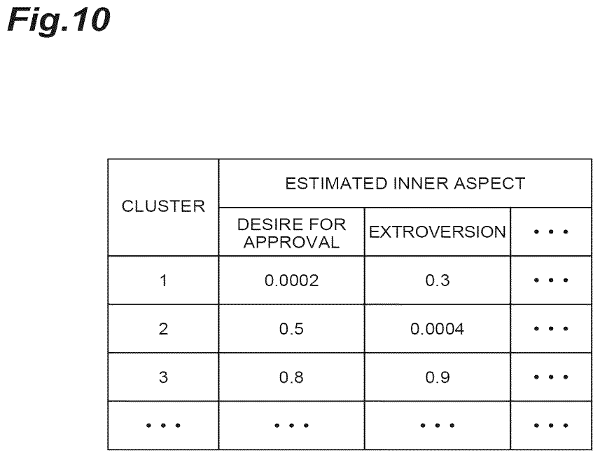

FIG. 10 is a diagram illustrating an example of feature values. For example, the inner aspect feature calculation unit 17 calculates the average value of the estimated inner aspects for each cluster as the feature value. The inner aspect feature calculation unit 17 may normalize the calculated feature value. FIG. 10 shows feature values associated with cluster identification numbers.

For example, for the cluster with identification number “1,” the inner aspect feature calculation unit 17 calculates an average value of “0.0002” for the desire for approval and an average value of “0.3” for extroversion. For the cluster with identification number “2,” the inner aspect feature calculation unit 17 calculates an average value of “0.5” for the desire for approval and an average value of “0.0004” for extroversion. For the cluster with identification number “3,” the inner aspect feature calculation unit 17 calculates an average value of “0.8” for the desire for approval and an average value of “0.9” for extroversion.

The inner aspect feature calculation unit 17 may determine the positive example user group P and similar clusters which are clusters similar to the positive example user group P by comparing the values of the axis inner aspects in the feature values between a plurality of clusters. For example, the axis inner aspects determined by the axis determination unit 14 are assumed to be “desire for approval” and “extroversion.” In this case, the inner aspect feature calculation unit 17 compares the value of the desire for approval and the value of extroversion for each cluster. In the example shown in FIG. 10, the value of the estimated inner aspect of the cluster with identification number “3” is the highest or has the greatest difference compared to the values of other clusters. In this case, the inner aspect feature calculation unit 17 determines the cluster with identification number “3” as a similar cluster. The inner aspect feature calculation unit 17 may output information such as a flag indicating whether the determined similar cluster is a similar cluster.

The inner aspect feature calculation unit 17 may calculate different types of inner aspects, which are inner aspects having high values among the feature values, for each of the dissimilar clusters which are clusters other than the similar clusters. In the example shown in FIG. 10, the inner aspect feature calculation unit 17 determines clusters other than the cluster with identification number “3” as dissimilar clusters. The inner aspect feature calculation unit 17 may output information such as a flag indicating whether the determined dissimilar cluster is a similar cluster.

In an example, the inner aspect feature calculation unit 17 calculates different types of inner aspects for the cluster with identification number “1” and the cluster with identification number “2” which are dissimilar clusters. For example, the different types of inner aspects of the cluster with identification number “1” may be, for example, “extroversion,” “cooperativeness,” and the like. The different types of inner aspects of the cluster with identification number “2” may be, for example, “desire for approval,” “aggressiveness,” and the like. The different types of inner aspects may overlap the axis inner aspects.

In step S9, the approach proposal device 10 estimates and outputs an approach for encouraging a behavior change. For example, the behavior change estimation unit 18 estimates and outputs an approach for encouraging a behavior change for each of the plurality of clusters using an inner aspect corresponding to a high value among the feature values. The behavior change estimation unit 18 may estimate an approach for encouraging a behavior change for a similar cluster using the axis inner aspects. The behavior change estimation unit 18 may estimate an approach for encouraging a behavior change for a dissimilar cluster using different types of inner aspects. the behavior change estimation unit 18 may display the estimated approach on a display device, or may transmit it to the terminal 100. For example, the behavior change estimation unit 18 may transmit an approach in the form of a message or the like to the terminals of users belonging to the cluster.

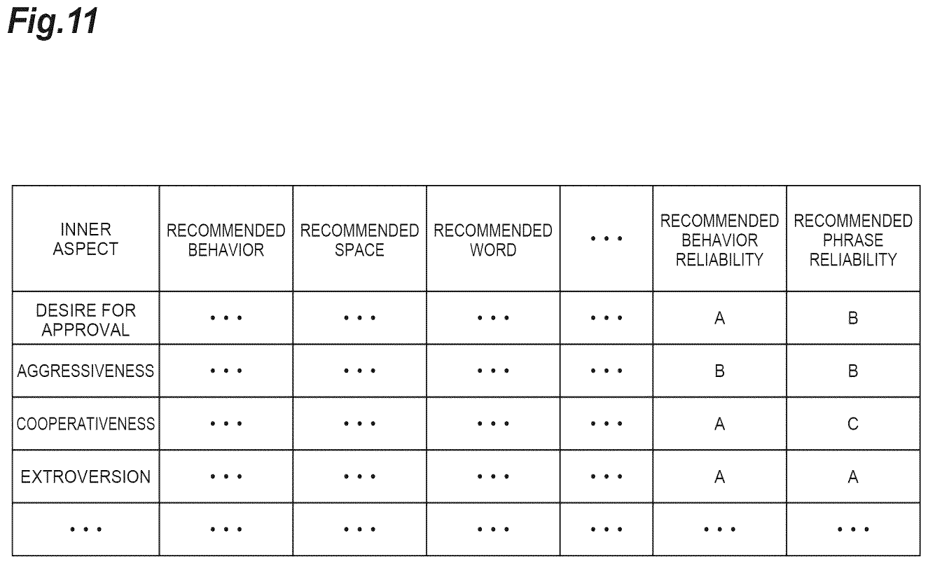

For example, the behavior change estimation unit 18 acquires various types of information from the behavior change database 30 using an inner aspect with a high feature value as an extract condition. FIG. 11 is a diagram illustrating an example of data stored in the behavior change database 30. The behavior change database 30 stores recommended approach and reliability levels in association with the inner aspect. The inner aspect can be uniquely identified. For example, the behavior change database 30 stores recommended behaviors, recommended spaces, and recommended words, as well as reliability of recommended behaviors and reliability of recommended phrases in association with the inner aspect. The information stored in the behavior change database 30 is not limited to these.

The recommended behaviors, recommended spaces, and recommended words are recommended behaviors, recommended spaces (locations, etc.), and words, respectively. The reliability of recommended behaviors and the reliability of recommended phrases are the reliability for the recommended behaviors, recommended spaces, and recommended words. The reliability is determined and corrected on the basis of the results of research or implementation. The reliability can be represented, for example, by three levels: A to C.

For example, the behavior change database 30 stores various types of information in association with the inner aspect “desire for approval.” The behavior change database 30 stores various types of information in association with the inner aspect “aggressiveness.” The behavior change database 30 stores various types of information in association with the inner aspect “cooperativeness.” The behavior change database 30 stores various types of information in association with the inner aspect “extroversion.”

For example, the behavior change estimation unit 18 may estimate and output a different approach for each of the plurality of clusters. For the cluster C2 shown in FIG. 9, the behavior change estimation unit 18 may estimate and output an approach of “creating a place where fans can interact with each other on-site.” The behavior change estimation unit 18 may estimate and output an approach of “creating an event can be participated in in a remote space” for the cluster C3 shown in FIG. 9.

Next, the operational effects of the approach proposal device 10 according to an aspect of the present disclosure will be described.

The approach proposal device 10 according to an aspect of the present disclosure includes an inner aspect estimation unit 12 configured to obtain estimated inner aspects which are results of estimating a plurality of inner aspects of users for a target user group T, which is a set of users serving as targets, using behavior data of the users, an inner aspect feature extraction unit 13 configured to use the estimated inner aspects to extract positive example inner aspects which are a plurality of inner aspects characteristic of a positive example user group P which is a set of users who are performing a predetermined behavior in the target user group T, a cluster identification unit 15 configured to identify a plurality of clusters for the target user group using at least some of the positive example inner aspects, and a behavior change estimation unit 18 configured to estimate and output an approach for encouraging a behavior change for each of the plurality of clusters on the basis of the estimated inner aspects.

In the approach proposal device 10 according to an aspect of the present disclosure, estimated inner aspects, which are results of estimating a plurality of inner aspects from behavior data, are output for each user in the target user group T. Positive example inner aspects, which are a plurality of inner aspects characteristic of the positive example user group P in the target user group T, are extracted from the estimated inner aspects. Clusters are specified for each user using at least some of the positive example inner aspects. For each cluster, an approach for encouraging a behavior change is estimated on the basis of the estimated inner aspects. According to such a configuration, the inner aspects characteristic of the positive example user group P are treated as positive example inner aspects, and an approach for encouraging a behavior change is estimated for each cluster in accordance with the estimated inner aspects. This allows different approaches to be estimated, for example, for clusters having dissimilar inner aspects. As a result, it is possible to approach users who have dissimilar inner aspects through the clusters.

For example, in the approach proposal device 10, estimated inner aspects are output for each fan of an idol. Among a set of fans of the idol, positive example inner aspects related to a set of fans who have participated in an event of the idol are extracted. Clusters are specified for each fan using at least some of the positive example inner aspects. An approach for encouraging a behavior change is then estimated for each cluster. For example, an approach of “creating a place where fans can interact with each other on-site” may be estimated and output for the cluster C2 shown in FIG. 9. An approach of “creating an event can be participated in in a remote space” may be estimated and output for the cluster C3 shown in FIG. 9. In addition, human workload can be reduced compared to a case where an approach is proposed by a person. Further, since users who belong to a cluster are approached according to their inner aspects, a pleasant user experience is expected.

The approach proposal device 10 includes an axis determination unit 14 that determines axis inner aspects which are a plurality of axes serving as references on the basis of the positive example inner aspects. The cluster identification unit 15 identifies a plurality of clusters using the axis inner aspects. In this case, the axis inner aspect is determined from the positive example inner aspects, and the cluster is specified based on the axis inner aspects. This makes it possible to identify clusters that place greater emphasis on the inner aspects characteristic of the positive example user group.

The cluster identification unit 15 identifies a plurality of clusters by comparing values of the axis inner aspects with a predetermined threshold and determining which of the clusters divided in accordance with a combination of the axis inner aspects the values correspond to. A simple determination method makes it possible to suppress an increase in calculation costs.

The approach proposal device 10 includes an inner aspect feature calculation unit that calculates feature values related to each of the estimated inner aspects for each of the plurality of clusters. The behavior change estimation unit estimates an approach for each of the plurality of clusters using an inner aspect corresponding to a high value among the feature values. In this case, an approach for encouraging a behavior change is estimated for each cluster in accordance with which inner aspect feature values are high. This makes it possible to estimate a more appropriate approach.

The inner aspect feature extraction unit 13 extracts the strength of features of the positive example inner aspects. The axis determination unit 14 determines the axis inner aspect on the basis of the ranking of the strength of features of the positive example inner aspects. In this case, the ranking of the strength of features of the positive example inner aspects is reflected in the determination of the axis inner aspect, and thus it is possible to determine a more appropriate axis inner aspect.

The inner aspect feature calculation unit 17 determines the positive example user group P and similar clusters which are clusters similar to the positive example user group P by comparing the values of the axis inner aspects in the feature values between a plurality of clusters. The behavior change estimation unit 18 estimates an approach for a similar cluster using the axis inner aspects. In this case, it is highly likely that users in the positive example user group P and users having inner aspects similar to the positive example user group P belong to the similar cluster. For the similar cluster, an approach according to the axis inner aspect is estimated, and thus it is possible to estimate a more appropriate approach.

The inner aspect feature calculation unit 17 calculates different types of inner aspects, which are inner aspects having high values among the feature values, for each of the dissimilar clusters which are clusters other than the similar clusters. The behavior change estimation unit 18 estimates an approach for dissimilar clusters using different types of inner aspects. In this case, different types of inner aspects corresponding to each of the dissimilar clusters are calculated. For dissimilar clusters, an approach according to different types of inner aspects is estimated, and thus it is possible to estimate a more appropriate approach.

The approach proposal device 10 includes a graph drawing unit 16 that draws a graph using the axis inner aspects for each of the plurality of clusters. In this case, how each cluster is represented for the axis inner aspects is visually provided. This makes it easy to ascertain the similarity between clusters based on the axis inner aspects. In addition, since the axes are set by the system when clusters are visualized, no human subjectivity or bias is involved. This makes it possible to obtain suggestions which are free from human bias through a visualized graph.

The approach proposal device of the present disclosure has the following configurations.
[1]

An approach proposal device comprising:
an inner aspect estimation unit configured to obtain estimated inner aspects which are results of estimating a plurality of inner aspects of users for a target user group, which is a set of users serving as targets, using behavior data of the users;
an inner aspect feature extraction unit configured to use the estimated inner aspects to extract positive example inner aspects which are a plurality of inner aspects characteristic of a positive example user group which is a set of users who are performing a predetermined behavior in the target user group;
a cluster identification unit configured to identify a plurality of clusters for the target user group using at least some of the positive example inner aspects; and
a behavior change estimation unit configured to estimate and output an approach for encouraging a behavior change for each of the plurality of clusters on the basis of the estimated inner aspects.
[2]

The approach proposal device according to [1], further comprising an axis determination unit configured to determine axis inner aspects which are a plurality of axes serving as references on the basis of the positive example inner aspects,
wherein the cluster identification unit identifies the plurality of clusters using the axis inner aspects.
[3]

The approach proposal device according to [2], wherein the cluster identification unit identifies the plurality of clusters by comparing values of the axis inner aspects with a predetermined threshold and determining which of the clusters divided in accordance with a combination of the axis inner aspects the values correspond to.
[4]

The approach proposal device according to [2] or [3], further comprising an inner aspect feature calculation unit configured to calculate a feature value related to each of the estimated inner aspects for each of the plurality of clusters,
wherein the behavior change estimation unit estimates the approach for each of the plurality of clusters using an inner aspect corresponding to a high value among the feature values.
[5]

The approach proposal device according to [4], wherein the inner aspect feature extraction unit extracts a strength of features of the positive example inner aspects, and
the axis determination unit determines the axis inner aspects on the basis of a ranking of the strength of features of the positive example inner aspects.
[6]

The approach proposal device according to [4] or [5], wherein the inner aspect feature calculation unit determines the positive example user group and a similar cluster which is a cluster similar to the positive example user group by comparing values of the axis inner aspects among the feature values between the plurality of clusters, and
the behavior change estimation unit estimates the approach for the similar cluster using the axis inner aspects.
[7]

The approach proposal device according to [6], wherein the inner aspect feature calculation unit calculates different types of inner aspects which are inner aspects having high values among the feature values for each of dissimilar clusters which are clusters other than the similar cluster, and
the behavior change estimation unit estimates the approach for the dissimilar clusters using the different types of inner aspects.
[8]

The approach proposal device according to any one of [4] to [7], further comprising a graph drawing unit configured to draw a graph using the axis inner aspects for each of the plurality of clusters.

Meanwhile, the block diagram used in the description of the above embodiment represents blocks in units of functions. These functional blocks (constituent elements) are realized by any combination of at least one of hardware and software. In addition, a method of realizing each functional block is not particularly limited. That is, each functional block may be realized using one device which is physically or logically coupled, or may be realized using two or more devices which are physically or logically separated from each other by connecting the plurality of devices directly or indirectly (for example, using a wired or wireless manner or the like). The functional block may be realized by combining software with the one device or the plurality of devices.

Examples of the functions include determining, deciding, judging, calculating, computing, processing, deriving, investigating, searching, ascertaining, receiving, transmitting, outputting, accessing, resolving, selecting, choosing, establishing, comparing, assuming, expecting, considering, broadcasting, notifying, communicating, forwarding, configuring, reconfiguring, allocating (or mapping), assigning, and the like, but there is no limitation thereto. For example, a functional block (constituent element) for allowing a transmitting function is referred to as a transmitting unit or a transmitter. As described above, realization methods are not particularly limited.

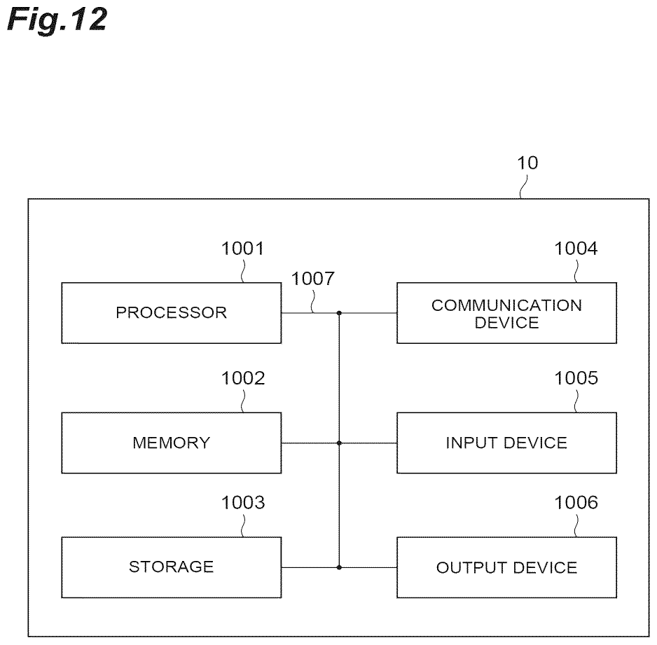

For example, the approach proposal system 1 in an embodiment of the present disclosure may function as a computer that performs information processing of the present disclosure. FIG. 12 is a diagram illustrating an example of a hardware configuration of the approach proposal system 1 according to an embodiment of the present disclosure. The approach proposal system 1 described above may be physically configured as a computer device including a processor 1001, a memory 1002, a storage 1003, a communication device 1004, an input device 1005, an output device 1006, a bus 1007, and the like. The hardware configuration of the terminal 100 may also be the one described herein.

Meanwhile, in the following description, the word “device” may be replaced with “circuit,” “unit,” or the like. The hardware configuration of the approach proposal system 1 may be configured to include one or a plurality of devices shown in the drawings, or may be configured without including some of the devices.

The processor 1001 performs an arithmetic operation by reading predetermined software (a program) onto hardware such as the processor 1001 or the memory 1002, and thus each function of the approach proposal system 1 is realized by controlling communication in the communication device 1004 or controlling at least one of reading-out and writing of data in the memory 1002 and the storage 1003.

The processor 1001 controls the whole computer, for example, by operating an operating system. The processor 1001 may be constituted by a central processing unit (CPU) including an interface with a peripheral device, a control device, an arithmetic operation device, a register, and the like. For example, each function in the approach proposal system 1 described above may be realized by the processor 1001.

In addition, the processor 1001 reads out a program (a program code), a software module, data, or the like from at least one of the storage 1003 and the communication device 1004 into the memory 1002, and executes various types of processes in accordance therewith. An example of the program which is used includes a program causing a computer to execute at least some of the operations described in the foregoing embodiment. For example, each function in the approach proposal system 1 may be realized by a control program which is stored in the memory 1002 and operates in the processor 1001. Although the execution of various types of processes by one processor 1001 has been described above, these processes may be simultaneously or sequentially executed by two or more processors 1001. The processor 1001 may be mounted on one or more chips. Meanwhile, the program may be transmitted from a network through an electrical communication line.

The memory 1002 is a computer readable recording medium, and may be constituted by at least one of, for example, a read only memory (ROM), an erasable programmable ROM (EPROM), an electrically erasable programmable ROM (EEPROM), a random access memory (RAM), and the like. The memory 1002 may be referred to as a register, a cache, a main memory (main storage device), or the like. The memory 1002 can store a program (a program code), a software module, or the like that can be executed in order to perform information processing according to an embodiment of the present disclosure.

The storage 1003 is a computer readable recording medium, and may be constituted by at least one of, for example, an optical disc such as a compact disc ROM (CD-ROM), a hard disk drive, a flexible disk, a magneto-optic disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium included in the approach proposal system 1 may be, for example, a database including at least one of the memory 1002 and the storage 1003, a server, or another suitable medium.

The communication device 1004 is hardware (a transmitting and receiving device) for performing communication between computers through at least one of a wired network and a wireless network, and is also referred to as, for example, a network device, a network controller, a network card, a communication module, or the like.

The input device 1005 is an input device (such as, for example, a keyboard, a mouse, a microphone, a switch, a button, or a sensor) that receives an input from the outside. The output device 1006 is an output device (such as, for example, a display, a speaker, or an LED lamp) that executes an output to the outside. Meanwhile, the input device 1005 and the output device 1006 may be an integrated component (for example, a touch panel).

In addition, respective devices such as the processor 1001 and the memory 1002 are connected to each other through the bus 1007 for communicating information. The bus 1007 may be configured using a single bus, or may be configured using different buses between devices.

In addition, the approach proposal system 1 may be configured to include hardware such as a microprocessor, a digital signal processor (DSP), an application specific integrated circuit (ASIC), a programmable logic device (PLD), or a field programmable gate array (FPGA), or some or all of the respective functional blocks may be realized by the hardware. For example, the processor 1001 may be mounted using at least one of these types of hardware.

The order of the processing sequences, the sequences, the flowcharts, and the like of the aspects/embodiments described above in the present disclosure may be changed as long as they are compatible with each other. For example, in the methods described in the present disclosure, various steps as elements are presented using an exemplary order but the methods are not limited to the presented specific order.

The input or output information or the like may be stored in a specific place (for example, a memory) or may be managed using a management table. The input or output information or the like may be overwritten, updated, or added. The output information or the like may be deleted. The input information or the like may be transmitted to another device.

Determination may be performed using a value (0 or 1) which is expressed by one bit, may be performed using a Boolean value (true or false), or may be performed by comparison of numerical values (for example, comparison thereof with a predetermined value).

The aspects/embodiments described in the present disclosure may be used alone, may be used in combination, or may be switched during implementation thereof. In addition, notification of predetermined information (for example, notification of “X”) is not limited to explicit transmission, and may be performed by implicit transmission (for example, the notification of the predetermined information is not performed).

Hereinbefore, the present disclosure has been described in detail, but it is apparent to those skilled in the art that the present disclosure should not be limited to the embodiments described in the present disclosure. The present disclosure can be implemented as modified and changed aspects without departing from the spirit and scope of the present disclosure, which are determined by the description of the scope of claims. Therefore, the description of the present disclosure is intended for illustrative explanation only, and does not impose any limited interpretation on the present disclosure.

Regardless of whether it is called software, firmware, middleware, microcode, hardware description language, or another name, software can be widely construed to refer to commands, a command set, codes, code segments, program codes, a program, a sub-program, a software module, an application, a software application, a software package, a routine, a sub-routine, an object, an executable file, an execution thread, a procedure, a function, or the like.

In addition, software, a command, information, and the like may be transmitted and received through a transmission medium. For example, when software is transmitted from a website, a server, or another remote source using at least one of wired technology (such as a coaxial cable, an optical fiber cable, a twisted-pair wire, or a digital subscriber line (DSL)) and wireless technology (such as infrared rays or microwaves), at least one of the wired technology and the wireless technology are included in the definition of a transmission medium.

The terms “system” and “network” which are used in the present disclosure are used interchangeably.

In addition, information, parameters, and the like described in the present disclosure may be expressed using absolute values, may be expressed using values relative to a predetermined value, or may be expressed using other corresponding information.

The term “determining” which is used in the present disclosure may include various types of operations. The term “determining” may include regarding operations such as, for example, judging, calculating, computing, processing, deriving, investigating, looking up/search/inquiry (for example, looking up in a table, a database or a separate data structure), or ascertaining as an operation such as “determining.” In addition, the term “determining” may include regarding operations such as receiving (for example, receiving information), transmitting (for example, transmitting information), input, output, or accessing (for example, accessing data in a memory) as an operation such as “determining.” In addition, the term “determining” may include regarding operations such as resolving, selecting, choosing, establishing, or comparing as an operation such as “determining.” That is, the term “determining” may include regarding some kind of operation as an operation such as “determining.” In addition, the term “determining” may be replaced with the term “assuming,” “expecting,” “considering,” or the like.

The terms “connected” and “coupled” and every modification thereof refer to direct or indirect connection or coupling between two or more elements and can include that one or more intermediate element is present between two elements “connected” or “coupled” to each other. The coupling or connecting of elements may be physical, may be logical, or may be a combination thereof. For example, “connection” may be read as “access.” In the case of use in the present disclosure, two elements can be considered to be “connected” or “coupled” to each other using at least one of one or more electrical wires, cables, and printed electric connections or using electromagnetic energy or the like having wavelengths in a radio frequency range, a microwave area, and a light (both visible light and invisible light) area as non-restrictive and non-comprehensive examples.

An expression “on the basis of” which is used in the present disclosure does not refer to only “on the basis of only,” unless otherwise described. In other words, the expression “on the basis of” refers to both “on the basis of only” and “on the basis of at least.”

Any reference to elements having names such as “first” and “second” which are used in the present disclosure does not generally limit amounts or an order of the elements. The terms can be conveniently used to distinguish two or more elements in the present disclosure. Accordingly, reference to first and second elements does not mean that only two elements are employed or that the first element has to precede the second element in any form.

In the present disclosure, when the terms “include,” “including,” and modifications thereof are used, these terms are intended to have a comprehensive meaning similarly to the term “comprising.” Further, the term “or” which is used in the present disclosure is intended not to mean an exclusive logical sum.

In the present disclosure, when articles are added by translation like, for example, “a,” “an” and “the” in English, the present disclosure may include that nouns that follow these articles are plural forms.

In the present disclosure, an expression “A and B are different” may mean that “A and B are different from each other.” Meanwhile, the expression may mean that “A and B are different from C.” The terms “separated,” “coupled,” and the like may also be construed similarly to “different.”

### REFERENCE SIGNS LIST

1 Approach proposal system
10 Approach proposal device
11 Input unit
12 Inner aspect estimation unit
13 Inner aspect feature extraction unit
14 Axis determination unit
15 Cluster identification unit
16 Graph drawing unit
17 Inner aspect feature calculation unit
18 Behavior change estimation unit
30 Behavior change database
20 Model management unit
21 Inner aspect database
22 Behavior database
23 Model creation unit
100 Terminal

1. An approach proposal device comprising circuitry configured to:
obtain estimated inner aspects which are results of estimating a plurality of inner aspects of users for a target user group, which is a set of users serving as targets, using behavior data of the users;
use the estimated inner aspects to extract positive example inner aspects which are a plurality of inner aspects characteristic of a positive example user group which is a set of users who are performing a predetermined behavior in the target user group;
identify a plurality of clusters for the target user group using at least some of the positive example inner aspects; and
estimate and output an approach for encouraging a behavior change for each of the plurality of clusters on the basis of the estimated inner aspects.

2. The approach proposal device according to claim 1, wherein the circuitry is further configured to determine axis inner aspects which are a plurality of axes serving as references on the basis of the positive example inner aspects, and
identify the plurality of clusters using the axis inner aspects.

3. The approach proposal device according to claim 2, wherein the circuitry identifies the plurality of clusters by comparing values of the axis inner aspects with a predetermined threshold and determining which of the clusters divided in accordance with a combination of the axis inner aspects the values correspond to.

4. The approach proposal device according to claim 2, wherein the circuitry further configured to calculate a feature value related to each of the estimated inner aspects for each of the plurality of clusters, and
estimate the approach for each of the plurality of clusters using an inner aspect corresponding to a high value among the feature values.

5. The approach proposal device according to claim 4, wherein the circuitry extracts a strength of features of the positive example inner aspects, and
determines the axis inner aspects on the basis of a ranking of the strength of features of the positive example inner aspects.

6. The approach proposal device according to claim 4, wherein the circuitry determines the positive example user group and a similar cluster which is a cluster similar to the positive example user group by comparing values of the axis inner aspects among the feature values between the plurality of clusters, and
estimates the approach for the similar cluster using the axis inner aspects.

7. The approach proposal device according to claim 6, wherein the circuitry calculates different types of inner aspects which are inner aspects having high values among the feature values for each of dissimilar clusters which are clusters other than the similar cluster, and
estimates the approach for the dissimilar clusters using the different types of inner aspects.

8. The approach proposal device according to claim 4, wherein the circuitry further configured to draw a graph using the axis inner aspects for each of the plurality of clusters.
